(19) United States
(12) Patent Application Publication
(10) Pub. No.: US 2008/0083428 A1
(43) Pub. Date: Apr. 10, 2008

(54) GANTRY METHOD OF WASHING VEHICLES

(76) Inventors: Peter B. Johnston, San Antonio, TX (US); Jon M. Leppo, Denver, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/865,340

(22) Filed: Oct. 1, 2007

Related U.S. Application Data
(60) Provisional application No. 60/828,538, filed on Oct. 6, 2006.

(51) Int. Cl. B08B 3/02; B08B 1/00; B08B 3/08

(52) U.S. Cl. 134/4; 134/6

(57) ABSTRACT

A method of washing a vehicle with a gantry-type apparatus in only two passes uses the first pass to apply a pre-wash solution while subsequently brushing the top and sides of the vehicle and a second pass to initially brush the sides of the vehicle, then apply a spot-free rinse solution to the vehicle, then brush the top of the vehicle and subsequently apply a drying agent alone or mixed with a spot-free rinse. When the drying agent is applied alone, a spot-free rinse is applied separately and subsequent to the application of the drying agent.

### CROSS REFERENCE TO RELATED APPLICATION

The present application claims the benefit under 35 U.S.C. § 119(e) to U.S. Provisional Patent Application No. 60/828,538 (“the '538 application”), which was filed on Oct. 6, 2006, and entitled “Gantry Method of Washing Vehicles.” The '538 application is incorporated by reference into the present application in its entirety.

### BACKGROUND OF THE INVENTION

1. Field of the Invention

The present invention relates generally to car wash systems and methods of operation thereof and more particularly to a method of washing a vehicle with a gantry-type apparatus wherein several operations are combined in passes of the gantry over the vehicle to shorten the time required for a complete wash of the vehicle.

2. Description of the Relevant Art

Apparatus for automatically washing vehicles and methods of operating the same have been popular and successful for a number of years. Such automatic car wash systems can be categorized as of the tunnel type or the gantry type. In a tunnel type car wash system, a vehicle is linearly advanced through a sequence of operations with a plurality of spaced apparatus provided for each operation applied to the vehicle as it passes thereby. For example, a vehicle in a tunnel type car wash system might first encounter an overhead frame that applies a presoak or soapy solution to the vehicle to break down dirt and grime on the surface of the vehicle. The vehicle might next encounter an overhead rinse apparatus that flushes the pre-soak solution from the vehicle. With subsequent apparatus a wax solution might thereafter be applied or a spot-free rinse and in some instances, brushes or other frictional mechanisms are utilized, and finally, air blowers might be utilized to dry the vehicle.

In gantry-type systems, a frame is adapted to be moved back and forth relative to a stationary vehicle with the gantry having a number of built-in nozzles and other components for delivering various operations to the vehicle in passes of the gantry back and forth over the vehicle. Originally, a gantry-type wash system would deliver a different operation to the vehicle in each pass across the vehicle either from the front of the vehicle to the rear or from the rear of the vehicle to the front. The various operations that can be delivered to the vehicle such as applying a pre-soak solution, applying a rinsing liquid, applying a wax to the vehicle, brushing the vehicle, applying a spot-free rinse to the vehicle, and the like, have necessitated a relatively long wash cycle which effects the economics of the car wash system even though a thorough cleansing of the vehicle can be obtained.

In recent years, gantry-type operations have been modified so that one or more operations may be accomplished in a single pass of the gantry across the vehicle. By increasing the number of operations in one pass, the time for a wash cycle can be shortened and the economics of the car wash operation improved.

Finding which operations can be accomplished in one pass of the gantry, however, has not been an easy matter and much thought has been given to which operations can be combined in individual passes without detrimentally affecting the quality of the car wash.

It is to further efforts in reducing the number of passes of a gantry-type wash system across a vehicle without detrimentally effecting the quality of the wash of the vehicle that the present invention has been developed.

### SUMMARY OF THE INVENTION

In accordance with the present invention, a gantry-type apparatus which has traditionally been used to wash a vehicle in four or more passes has been modified so that the vehicle is thoroughly washed in two passes of the gantry across the vehicle. The gantry utilized includes a plurality of nozzle sets through which various fluids associated with the cleansing of the vehicle can be applied to the vehicle and rotating brushes disposed adjacent to the top and both sides of the vehicle.

In a first pass of the gantry across the vehicle, a pre-soak solution is applied and subsequently the top and side brushes engage the associated sides of the vehicle to thoroughly remove any dirt and grime from the surface of the vehicle. In the second or reverse pass of the gantry across the vehicle, four distinct operations are applied to the vehicle. Initially, as the gantry moves along the length of the vehicle, the side brushes are rotated to again brush the sides of the vehicle and immediately thereafter the top brush is lowered into engagement with the top of the vehicle. Behind the top brush, a drying agent, which may or may not be mixed with spot-free rinse water, is applied to the vehicle with the drying agent being effective to cause the water to bead, which facilitates a quicker drying of the vehicle. In lieu of the drying agent, a wax product may be applied to the vehicle immediately after the top brush depending upon the desires of the vehicle owner. If the drying agent is not mixed with a spot-free rinse, a spot-free rinse can be applied to the vehicle after the drying agent.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric of a gantry-type car wash apparatus for use in the method of the present invention.

FIG. 2 is a front elevation of the apparatus of FIG. 1 with a vehicle positioned there beneath.

FIG. 3 is a vertical section through the apparatus of FIG. 2 illustrating an inner side and a portion of the top of the apparatus with the apparatus positioned at the front of a vehicle shown in dashed lines.

FIG. 4 is a front elevation of the apparatus similar to FIG. 2 with a vehicle shown in dashed lines and with the apparatus moving from the front of the vehicle toward the rear of the vehicle in a first pass of the apparatus across the vehicle.

FIG. 5 is a vertical section similar to FIG. 3 with the apparatus positioned approximately mid-way along the length of the vehicle in a pass across the vehicle.

FIG. 6 is vertical section similar to FIG. 5 with the apparatus moving from the rear of the vehicle to the front of the vehicle in the second pass of the apparatus across the vehicle.

FIG. 7 is an isometric similar to FIG. 1 showing an apparatus for practicing a second embodiment of the method of the present invention.

FIG. 8 is a side elevation of the apparatus shown in FIG. 7 with a vehicle being shown in dashed lines.

### DETAILED DESCRIPTION OF THE INVENTION

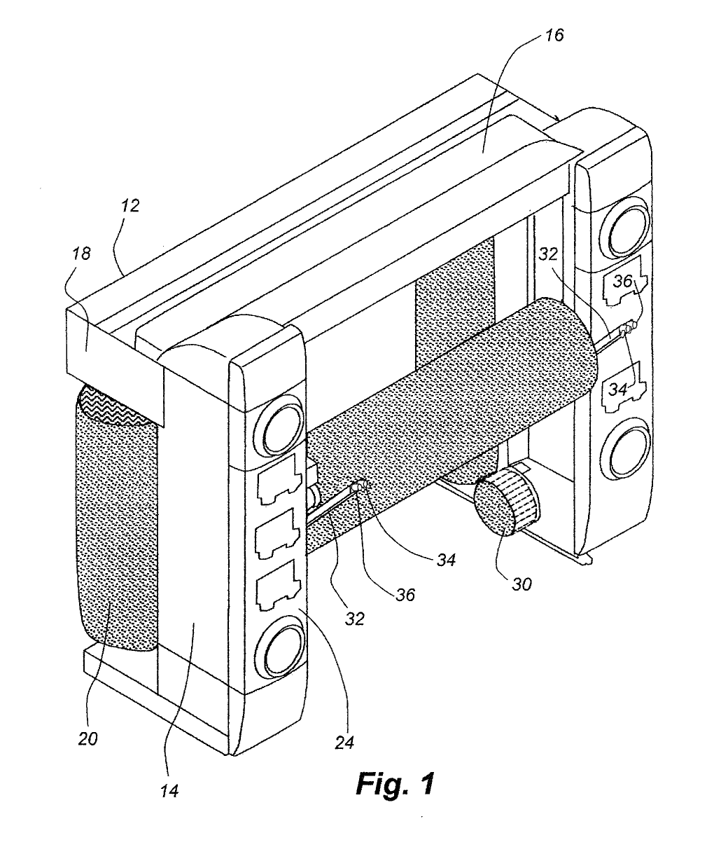

An apparatus 10 that could be used in practicing the method of the present invention is illustrated in FIGS. 1-6 and can be seen to be of the gantry type having an inverted U-shape frame 12. In use, the gantry is driven in a reciprocal manner along a path of travel so as to pass in reverse directions over a stationary vehicle V positioned therebeneath. The movement of the gantry in reversible directions is well known in the art and accordingly, the system for driving the gantry is not illustrated. Further, the gantry includes on board or at a remote location, a computerized system (not shown) for driving the gantry in reversible directions and for simultaneously operating the various mechanisms carried by the gantry for washing a vehicle, which will be described hereafter.

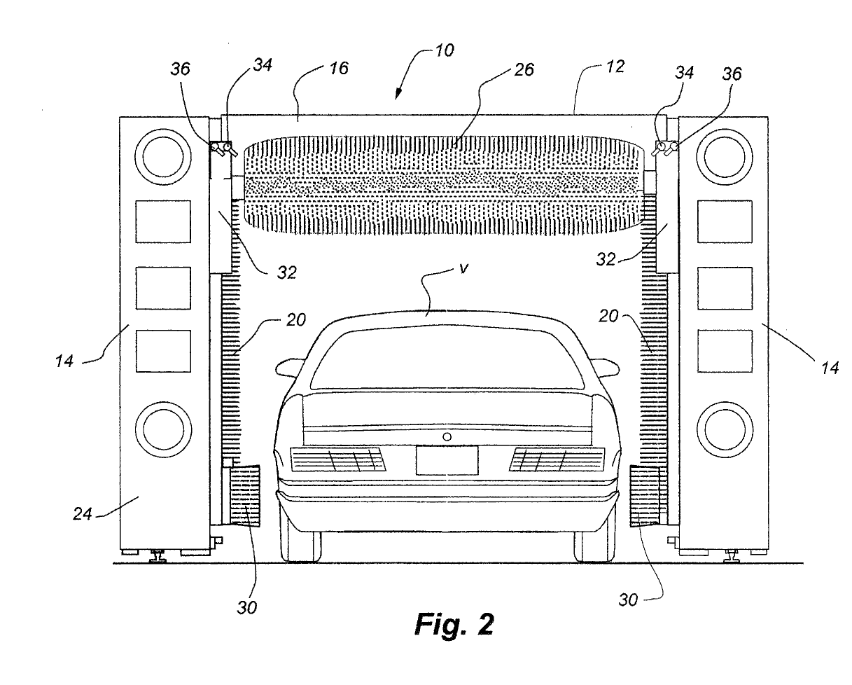

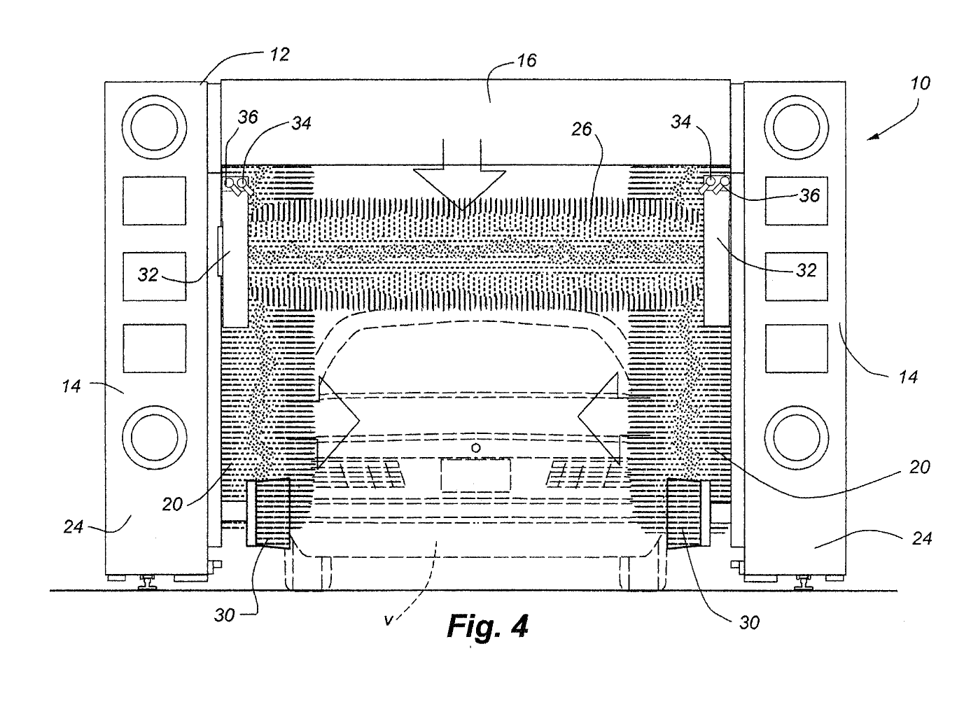

As will be appreciated by the various views of the apparatus, the gantry includes a pair of vertical side segments 14 and an interconnecting top segment 16 that define a space therebeneath so the gantry can be reciprocably driven along the length of the vehicle V. Along a rear edge 18 of each side segment, a pair of vertically extending generally cylindrical side brushes 20 is mounted on pivotal arms 22 so the side brushes can be swung between a retracted position (FIG. 2) and an extended or engaging position (FIG. 4). Similarly, along the front edge 24 of the gantry, a generally cylindrical top brush 26, which is horizontally disposed is mounted on a vertically reciprocable support system 28. The support system allows the top brush to be raised or lowered between an elevated position (FIG. 2) and a lowered position (FIG. 4). The lowered position is variable so as to follow the profile of the vehicle whereby the top brush can be in a relatively low position when engaging the hood and trunk of the vehicle and in a relatively higher position when engaging the top of the vehicle with the profile of the vehicle being determined by a profiling system which is known in the trade and will not be described in detail herein.

While various types of friction brushes known in the trade can be used with the apparatus, in the disclosed embodiment, both the two vertical side brushes 20 and the top brush 26 are rotatable about longitudinal axes. In addition, a pair of wheel brushes 30 of a circular configuration are moveable inwardly and outwardly to engage the wheels and lower sides of the vehicle and while being independently mounted, will typically be extended and retracted in unison with the side brushes 20.

Adjacent to the front edge 24 of the gantry and mounted on the same vertically reciprocable support system 28 as the top brush 26 are a pair of upwardly and forwardly angled support arms 32 disposed at opposite sides of the gantry. Each support arm is provided with two nozzles 34 and 36 adjacent to its outer end and forwardly of the front edge 24 with the nozzles being connected to separate sources of fluid for use in washing a vehicle as will be described hereafter. Associated nozzles on each arm are connected to the same source of fluid as will be clearer with the description that follows.

Disposed on each side segment 14 of the gantry along a proximate centerline are three vertical arrays of nozzles 38, 40 and 42, which would normally be connected to separate and distinct sources of washing fluids, but for purposes of the method of the present invention, none of these nozzles is necessary. A vertically disposed vent 44 for an air dryer (not shown) is also disposed in each side segment if it was desired in the apparatus to include a blow drying operation.

Another set of spray nozzles 46 are disposed across the top segment 16 of the gantry with downwardly directed nozzles for spraying across the top of the vehicle. This set of nozzles is correlated with the set of nozzles 42 in each side segment 14 so when fluids are dispensed from the upper set of nozzles 46, it is also dispensed from the side set of nozzles 42, but the nozzles 46 are not necessary for the method of the present invention for the same reason the nozzles 42 are not necessary.

The apparatus described can be used in numerous processes which might involve two or more passes of the gantry along the length of the vehicle wherein each pass might involve one or more of the following operations:

a) application of a shampoo/pre-wash; b) brushing the sides and/or top of the vehicle; c) applying a spot-free rinse; d) applying a drying agent; or e) applying a wax product. Each operation can be performed in a distinct pass of the apparatus along the length of the vehicle in a predetermined sequence for obtaining cleansing of the vehicle, but in accordance with the present invention, some of the operations are combined in a unique manner so that the vehicle is desirably cleaned with only two passes of the gantry along the length of the vehicle.

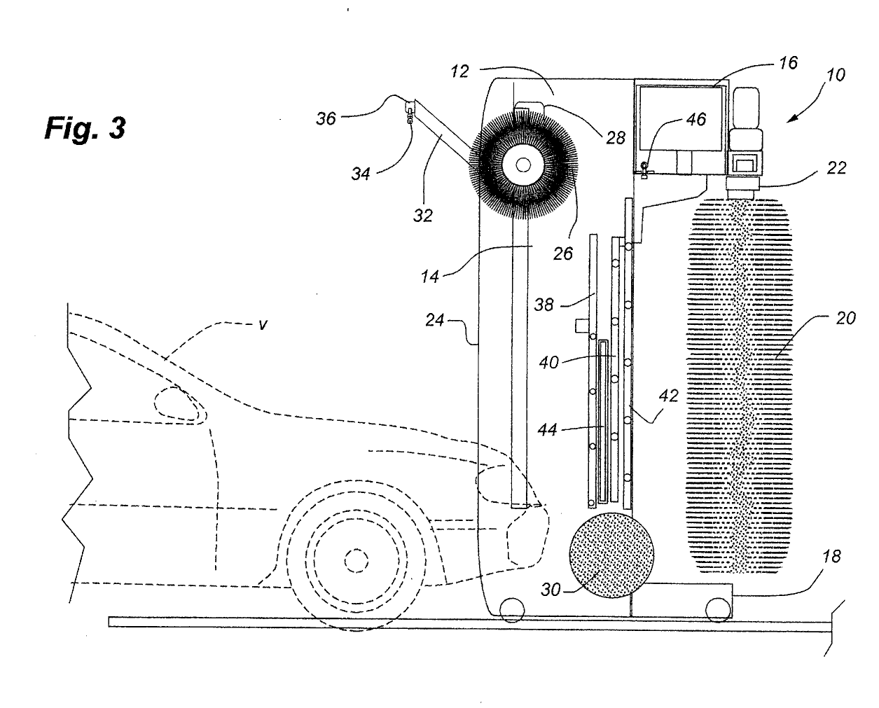

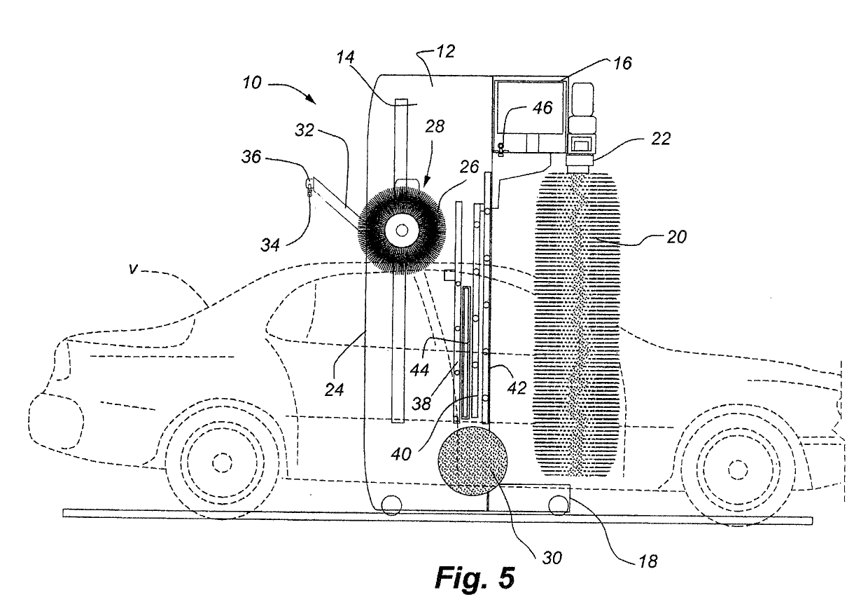

In accordance with the two-pass method of the present invention, when a vehicle V first approaches the gantry 10 as shown in FIG. 3, it is stopped with the gantry positioned adjacent the front end of the vehicle. Once the vehicle is stationary, the gantry is moved from the front of the vehicle to the rear of the vehicle. During this first pass of the gantry along the length of the vehicle, a shampoo or pre-wash solution is applied to the vehicle with associated nozzles 34 of a first set on the angled support arms 32. The pre-soak solution is of a known type and is designed to break down greases, grime or other dirt that may be on the vehicle so that it is more easily removed from the surface of the vehicle without damaging the paint on the vehicle. Also during the first pass, the side brushes 20 are moved into engagement with the sides of the vehicle as shown in FIG. 4. and the top brush 26 is also lowered with the reciprocal support system 28 to follow the top contour of the car so that as the brushes are rotating, all top and side surfaces of the vehicle are engaged by the brushes to assist the pre-soak solution in frictionally removing dirt, grime and other materials. As will be appreciated, since the top brush follows the top contour of the vehicle and the first set of nozzles 34 applying the shampoo or pre-wash solution is moving with the top brush, these nozzles remain relatively close to the top surface of the vehicle so they spray dependably across the exposed surfaces of the vehicle. Further, as can be seen in FIG. 4, the nozzles 34 on the angled support arms 32 are angled inwardly and downwardly so they spray the shampoo or pre-soak solution across the top and sides of the vehicle before the brushes engage the vehicle. FIG. 5 is illustrative of the position of the brushes and nozzles as the gantry moves from the front of the vehicle toward the rear during the first pass.

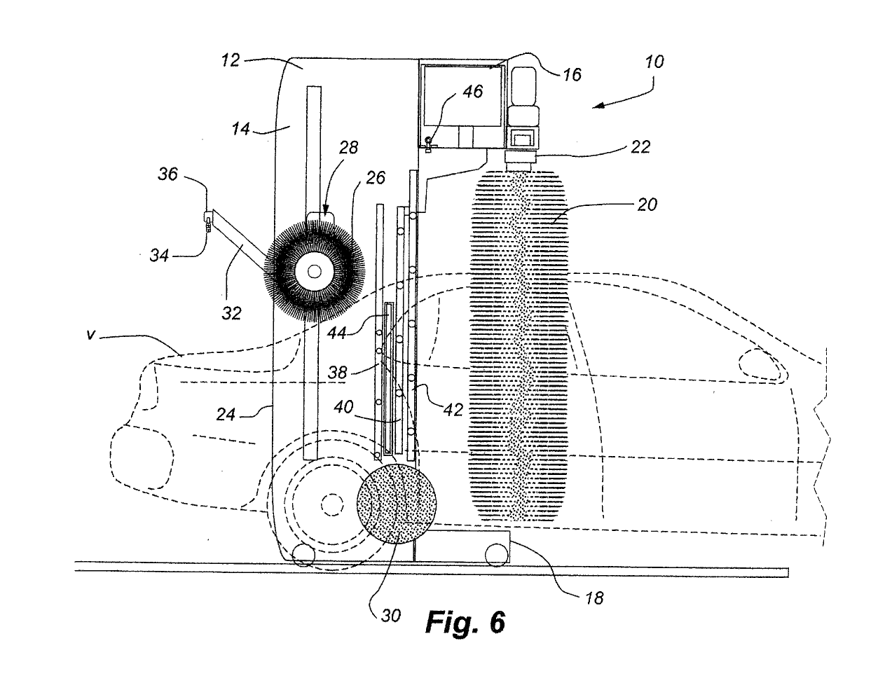

When the gantry 10 reaches the rear end of the vehicle, it pauses and then is reversed in direction so as to move along the length of the vehicle toward the front of the vehicle as shown for example in FIG. 6 in a second pass. During this pass of the gantry, the side brushes 20 as well as the top brush 26 are moved into engagement with the vehicle as shown in FIG. 4, and a spot-free rinse mixed with a drying agent is emitted through the nozzles 36 on the angled support arms 32 with the nozzles 36 being angled to also spray the top and sides of the vehicle. The drying agent and spot-free rinse are well known in the trade with the spot-free solution being adapted to minimize water spots on the vehicle after it has been dried and the drying agent being adapted to bead the water so it dries more quickly.

As will be appreciated by reference to FIGS. 4 and 6 for example, which illustrate the apparatus moving in the second pass, the above-described operations occur simultaneously from the gantry. Referencing one location along the length of the vehicle V, the vehicle is first brushed with the side brushes 20. Next, the top brush 26 frictionally engages the top surface of the vehicle, and finally the mixture of drying agent and spot-free rinse cover the vehicle. With this sequence of operations, it has been found each operation is effective on the vehicle and in combination desirably finishes the wash process in a manner such that the vehicle is desirably cleansed and will dry in a short period of time. Also, by spraying the drying agent and spot-free rinse mixture from a close spacing following the top contour of the vehicle, optimal effects and coverage by this solution are achieved. It has been determined if a vehicle owner wanted wax on the vehicle, a conventional wax solution could be used in lieu of the drying agent. In other words, the wax would be mixed with spot-free rinse instead of a drying agent.

When the gantry 10 reaches the front of the vehicle V after the second pass, the vehicle wash is complete and the vehicle can be advanced out of the car wash area. The gantry is also then desirably positioned for accepting a second vehicle since the gantry is positioned at the front of the vehicle for initiation of the first pass of a second wash as described above.

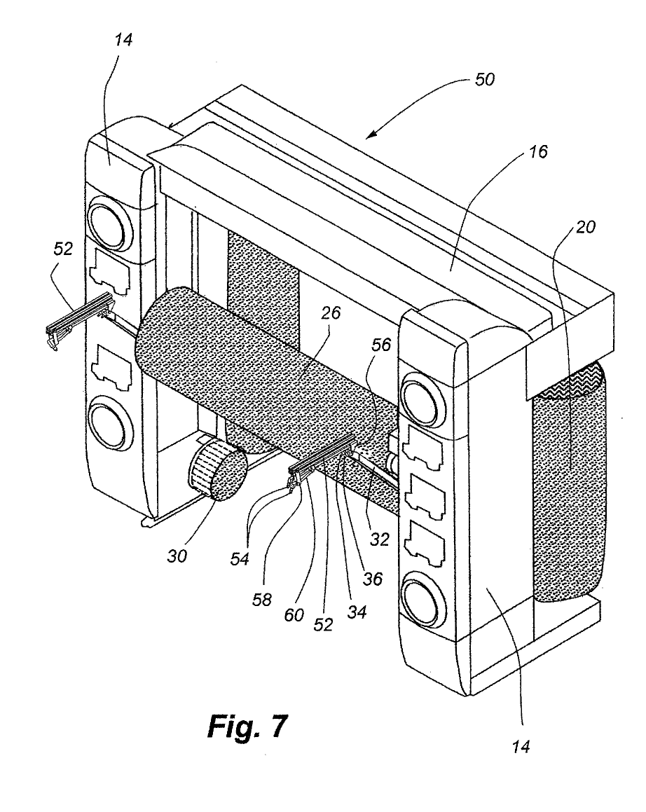

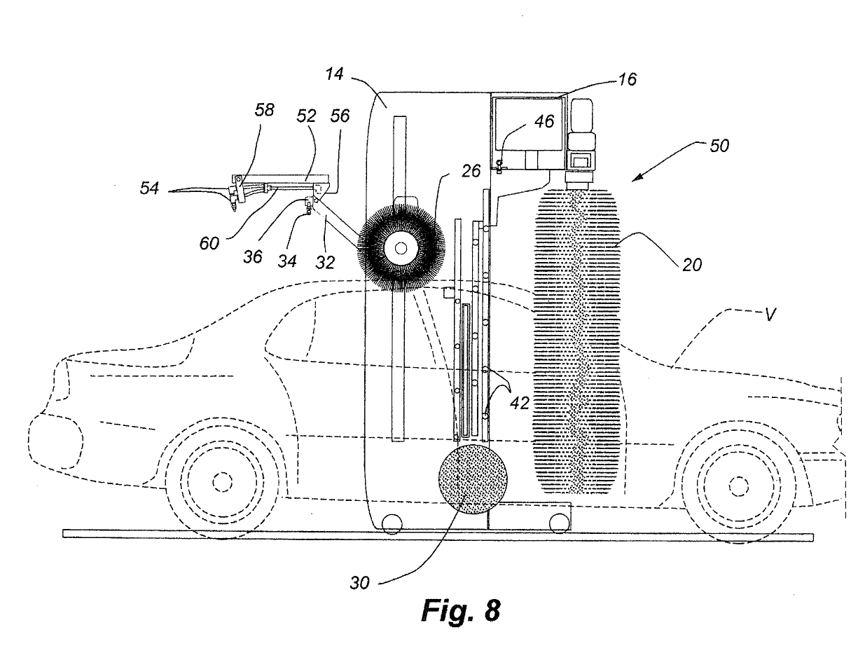

As an alternative embodiment of the method described previously, the apparatus could be used in another two-pass operation or method with minor adjustments as illustrated in FIGS. 7 and 8.

In FIGS. 7 and 8, an apparatus 50 similar to that described in FIGS. 1-6 is shown with like parts having like reference numerals, but auxiliary support arms 52 have been mounted on the distal ends of the support arms 32 with two additional nozzles 54 mounted on the distal end of each auxiliary support arm. The two additional nozzles are angled relative to each other so as to spray a common fluid across the sides and the top of a vehicle V beneath the gantry. It is important to note the distal end of each auxiliary support arm 52 is horizontally spaced from the distal end of the support arm 32, so that fluids being sprayed from the additional nozzles 54 on the auxiliary support arms will impact a given point on the vehicle V at a different time than fluid sprayed from the nozzles 36 on the support arms 32 due to the movement of the gantry relative to the vehicle. This occurs even though fluids are simultaneously sprayed from the nozzles 36 and the additional nozzles 54 due to the horizontal displacement of the nozzles 36 from the additional nozzles 54 whereby the fluids emitted therefrom impact a pre-designated location of the vehicle at different times.

Each auxiliary support arm 52 has its proximal end secured to the distal end of an associated support arm 32 with a fixed bracket 56 so the auxiliary support arm extends horizontally and forwardly away from the distal end of the support arm 32. A nozzle support bracket 58 is secured to the distal end of the auxiliary support arm to support the additional spray nozzles 54, which are connected through suitable hosing 60 to a common source of fluid (not shown) to be emitted onto the vehicle.

In operation, the apparatus 50 of FIGS. 7 and 8 is somewhat similar to that described previously with regard to FIGS. 1-6 except the nozzles 36 do not spray a mixture of spot-free rinse and drying agent or wax as in the first-described embodiment of the method. Rather, the nozzles 36 spray only a drying agent, or as an alternative a wax solution, while the nozzles 54 on the auxiliary arms 52 spray only a spot-free rinse.

Accordingly, the second embodiment of the method of the present invention in a first pass is identical to the method previously described in connection with the apparatus of FIGS. 1-6 wherein a pre-wash or shampoo solution is sprayed through the nozzles 34 onto the vehicle as the gantry moves from the front of the vehicle toward the rear of the vehicle. The side brushes 20, as well as the top brush 26, are engaged with the vehicle to scrub the vehicle with the pre-wash solution thereon. When the gantry reaches the rear of the vehicle, it is paused, as described in the first-described method, and then begins its movement from the rear of the vehicle toward the front of the vehicle. In this pass, the side brushes and the top brush are again engaged with the vehicle. Also during this pass, as mentioned previously, a spot-free rinse solution is sprayed from the nozzles 54 on the auxiliary arm, and a drying agent or wax solution is sprayed through the nozzles 36 on the support arm 32. In other words, in the second embodiment of the method of the present invention, the only distinction resides in the fact that the mixture of spot-free rinse and drying agent or wax solution used in the first-described embodiment and sprayed through the nozzles 34 is no longer sprayed as a mixture, but rather, the spot-free rinse solution and the drying agent or wax are separated and applied to the vehicle through different nozzles, which are horizontally displaced so the spot-free rinse emitted from the nozzles on the auxiliary support arms 52 are actually applied to the vehicle subsequent to the drying agent or wax solution due to the movement of the gantry and the horizontal displacement of the nozzles 34 from the nozzles 54.

In accordance with the above, it will be appreciated a method of using a gantry-type apparatus and an alternative embodiment thereof having various car wash operation capabilities have been described so that these operations can be applied in predetermined unique groupings to obtain a desired wash of a vehicle and in a minimum of time, i.e., the time it takes for the gantry to go through two passes along the length of the vehicle. Accordingly, not only is the vehicle desirably cleaned, but also it is done in a minimal amount of time so that economic efficiencies are obtained.

Although the present invention has been described with a certain degree of particularity, it is understood the disclosure has been made by way of example, and changes in detail or structure may be made without departing from the spirit of the invention as defined in the appended claims.

What is claimed is:

1. A method of washing a vehicle with an apparatus adapted to reciprocate along the length of the vehicle in passes, said apparatus including a frame with vertical side segments and an interconnecting top segment, a front edge and a rear edge, a pair of vertically disposed side brushes mounted on said side segments adjacent to the rear edge, side nozzles in said side segments and top nozzles in said top segment positioned intermediate said front and rear edges, a horizontally disposed top brush adjacent to said front edge, and first and second pairs of nozzles in front of said front edge, said method comprising the steps of:
applying a pre-wash solution to said vehicle in a first pass, and
in a second pass sequentially (a) brushing the sides of the vehicle, (b) applying a spot-free rinse to the vehicle, (c) brushing the top of the vehicle, and (d) applying a mixture of drying agent and spot-free rinse to the vehicle.

2. The method of claim 1 further including the step of brushing the vehicle in the first pass after the application of said pre-wash solution.

3. The method of claim 2 wherein the sides and the top of the vehicle are brushed in the first pass.

4. The method of claim 1 wherein a wax solution is used in said second pass in lieu of said drying agent.

5. The method of claim 1 wherein said pre-wash solution is applied through said first pair of nozzles, said spot-free rinse is applied through said side and top nozzles, and said mixture of drying agent and spot-free rinse is applied through said second pair of nozzles.

6. The method of claim 4 wherein said pre-wash solution is applied through said first pair of nozzles, said spot-free rinse is applied through said side and top nozzles, and said mixture of wax solution and spot-free rinse is applied through said second pair of nozzles.

7. The method of claim 1 wherein the application of said pre-wash solution is from at least one nozzle that follows the top contour of the vehicle so as to remain substantially uniformly spaced from the top of the vehicle during the first pass.

8. A method of washing a vehicle with an apparatus adapted to reciprocate along the length of the vehicle in passes, said apparatus including a frame with vertical side segments and an interconnecting top segment, a front edge and a rear edge, a pair of vertically disposed side brushes mounted on said side segments adjacent to the rear edge, side nozzles in said side segments and top nozzles in said top segment positioned intermediate said front and rear edges, a horizontally disposed top brush adjacent to said front edge, first and second pairs of nozzles in front of said front edge, and at least a third pair of nozzles forwardly of said first and second pairs of nozzles, said method comprising the steps of:
applying a pre-wash solution to said vehicle in a first pass, and
in a second pass sequentially (a) brushing the sides of the vehicle, (b) applying a spot-free rinse to the vehicle, (c) brushing the top of the vehicle, (d) applying a drying agent or a wax solution to the vehicle, and (e) applying additional spot-free rinse to the vehicle.

9. A method of washing a vehicle with an apparatus adapted to reciprocate along the length of the vehicle in passes, said apparatus including a frame with vertical side segments and an interconnecting top segment, a front edge and a rear edge, a pair of vertically disposed side brushes mounted on said side segments adjacent to the rear edge, side nozzles in said side segments and top nozzles in said top segment positioned intermediate said front and rear edges, a horizontally disposed top brush adjacent to said front edge, first and second pairs of nozzles in front of said front edge, and at least a third pair of nozzles forwardly of said first and second pairs of nozzles, said method comprising the steps of:
applying a pre-wash solution to said vehicle in a first pass, and
in a second pass brushing the sides and top of the vehicle and sequentially (a) applying a spot-free rinse to the vehicle, (b) applying a drying agent or wax solution to the vehicle, and (c) applying additional spot-free rinse to the vehicle.

10. The method of claim 9 further including the step of brushing the vehicle in the first pass after the application of the pre-wash solution.

11. The method of claim 10 wherein the sides and top of the vehicle are brushed in the first pass.

12. The method of claim 9 wherein said pre-wash solution is applied through said first pair of nozzles, said spot-free rinse is applied through said side and top nozzles as well as said at least a third pair of nozzles, and said drying agent or wax solution is applied through said second pair of nozzles.

13. The method of claim 9 wherein said pre-wash solution is applied through at least one nozzle that follows the top contour of the vehicle so as to remain substantially uniformly spaced from the top of the vehicle during the first pass.

14. A method of washing a vehicle with an apparatus adapted to reciprocate along the length of the vehicle in passes, said apparatus including a frame with vertical side segments and an interconnecting top segment, a front edge and a rear edge, a pair of vertically disposed side brushes mounted on said side segments adjacent to the rear edge, side nozzles in said side segments and top nozzles in said top segment positioned intermediate said front and rear edges, a horizontally disposed top brush adjacent to said front edge, first and second pairs of nozzles in front of said front edge, and at least a third pair of nozzles forwardly of said first and second pairs of nozzles, said method comprising the steps of:
applying a pre-wash solution to said vehicle in a first pass, and
in a second pass brushing the sides and top of the vehicle and sequentially (a) applying a spot-free rinse to the vehicle, and (b) applying a mixture of spot-free rinse and drying agent or wax solution to the vehicle.
